(19) United States
(12) Patent Application Publication
(10) Pub. No.: US 2025/0112237 A1
(43) Pub. Date: Apr. 3, 2025

(54) NEGATIVE ELECTRODE ACTIVE MATERIAL, SECONDARY BATTERY, AND METHOD FOR MANUFACTURING NEGATIVE ELECTRODE ACTIVE MATERIAL

(71) Applicant: DIC Corporation, Tokyo (JP)

(72) Inventors: Peixin Zhu, Chiba (JP); Kenichi Kawase, Chiba (JP)

(73) Assignee: DIC Corporation, Tokyo (JP)

(21) Appl. No.: 18/715,930

(22) PCT Filed: Oct. 27, 2022
(86) PCT No.: PCT/JP2022/040066

§ 371 Date: Jun. 3, 2024

(30) Foreign Application Priority Data
Dec. 3, 2021 (JP) 2021-197251

(51) Int. Cl. H01M 4/583; H01M 4/02; H01M 4/04; H01M 4/38; H01M 4/62; H01M 10/052

(52) U.S. Cl. CPC H01M 4/583; H01M 4/0404; H01M 4/386; H01M 4/62; H01M 10/052; H01M 2004/021; H01M 2004/027

(57) ABSTRACT

A negative electrode active material giving a secondary battery having high initial discharge capacity, capacity retention rate, and charge-discharge capacity and having an excellent balance of these characteristics is provided. The negative electrode active material has a granular structure having a surface uneven part and mainly contains graphite and a surface layer with silicon particles with an average particle size of 20 nm to 200 nm dispersed in a matrix phase at least on part of the surface of the granular structure. The silicon particles are flake-like and crystalline, and a crystallite size with 2θ of 28.4° in X-ray diffraction is 40 nm or less.

### TECHNICAL FIELD

The present invention relates to a negative electrode active material and a secondary battery containing the negative electrode material. The present invention also relates to a method for manufacturing the negative electrode active material.

### BACKGROUND ART

Nonaqueous electrolyte secondary batteries are used in portable devices, hybrid vehicles, electric vehicles, and household storage batteries and are required to have a good balance of multiple characteristics including electric capacity, safety, and operational stability.

A nonaqueous electrolyte secondary battery mainly contains a lithium intercalation compound releasing lithium ions from between layers as a negative electrode material and can occlude and release lithium ions between layers between crystal planes during charging and discharging. For example, various lithium-ion batteries containing carbonaceous materials such as graphite as a negative electrode active material have been developed and put into practical use.

In recent years, with the miniaturization of various electronic devices and communication devices and the rapid spread of hybrid vehicles, there have been a strong demand for the development of secondary batteries with higher capacity and further improved various battery characteristics such as cycle characteristics and discharge rate characteristics as power sources for driving these devices and the like.

For the purpose of further increasing the capacity of secondary batteries, attempts are being made to use silicon, an element having high theoretical capacity and capable of occluding and releasing lithium ions, in combination with graphite or the like conventionally used as negative electrode active materials.

For example, PTL 1 and 2 disclose soft carbon materials for a lithium-ion secondary battery negative electrode material containing a nanomaterial coating supported on the surface layer of soft carbon powder particles and a conductive carbon layer covering the outer surface of the nanomaterial coating. However, soft carbon supporting nanomaterials may have many voids. If many voids are present, the effect of preventing contact between the nanomaterials and an electrolyte during charging and discharging is limited, and consequently, a decomposition reaction of the electrolyte may proceed on the nanoparticles, and performance degradation of the active material may not be able to be avoided.

PTL 3 discloses a negative electrode material containing composite particles in which amorphous carbon containing specific nanosilicon adheres to the surface of graphite particles. PTL 4 discloses a negative electrode material for a lithium-ion battery provided with a reticular structure having a granular active material made of graphite and a plurality of C—O—Si bonds on part of the surface of the granular active material.

### CITATION LIST

### Patent Literature

PTL 1: Japanese Unexamined Patent Application Publication No. 2015-128045
PTL 2: Japanese Unexamined Patent Application Publication (Translation of PCT Application) No. 2017-526118
PTL 3: WO 2020/088248
PTL 4: Japanese Unexamined Patent Application Publication No. 2020-64876

### SUMMARY OF INVENTION

### Technical Problem

However, even with the negative electrode active materials described in the literature, further improvement in initial discharge capacity and capacity retention rate when used as secondary batteries is demanded. Also demanded is further improvement in charge-discharge capacity.

The inventors of the present invention focused on the bonding strength between graphite, which is the base material of the negative electrode active material, and silicon particles used in combination, and have found that further improvement in the performance of the negative electrode active material is possible by increasing the bonding strength of the two to complete the present invention.

That is, an object of the present invention is to provide a negative electrode active material giving a secondary battery having high initial discharge capacity, capacity retention rate, and charge-discharge capacity and having an excellent balance of these characteristics.

### Solution to Problem

The present invention has the following aspects:

[1] A negative electrode active material having a granular structure having a surface uneven part and mainly containing graphite and a surface layer with silicon particles with an average particle size of 20 nm to 200 nm dispersed in a matrix phase at least on part of the surface of the granular structure.

[2] The negative electrode active material according to [1] above, in which the silicon particles are flake-like and crystalline, and a crystallite size with 2θ of 28.4° in X-ray diffraction is 40 nm or less.

[3] The negative electrode active material according to [1] or [2] above, in which a penetration depth of the surface layer into an interior of recesses of the granular structure satisfies Expression (1) below:

0.01≤B/A≤0.3 (1)
in Expression (1), A represents an average particle size of the granular structure and B represents the penetration depth of the surface layer into the interior of the recesses.

[4] The negative electrode active material according to any one of [1] to [3] above, in which the granular structure has a cumulative pore volume of pore size in a range of 3 nm to 300 nm of 0.001 cm³/g or more.

[5] The negative electrode active material according to any one of [1] to [4] above, in which the graphite is natural graphite or artificial graphite, and the graphite has an average particle size of 1 μm to 25 μm and a specific surface area of 0.5 m²/g to 20 m²/g.

[6] The negative electrode active material according to any one of [1] to [5] above, in which a mass of the surface layer is 1% by mass to 80% by mass with an entire mass of the negative electrode active material as 100%.

[7] The negative electrode active material according to any one of [1] to [6] above, in which the surface layer contains silicon oxycarbide, amorphous carbon, and the silicon particles, and the silicon particles are 1 to 80% by mass with an entire mass of the surface layer as 100% by mass.

[8] The negative electrode active material according to [7] above, in which the surface layer further contains nitrogen.

[9] The negative electrode active material according to any one of [1] to [8] above, in which a particle size of the silicon particles is broadly distributed in 5 nm to 300 nm.

[10] The negative electrode active material according to any one of [1] to [9] above, in which the granular structure has an average particle size of 1 μm to 30 μm and a specific surface area of 1 m²/g to 30 m²/g.

[11] The negative electrode active material according to any one of [1] to [10] above, further having a carbon coating on the surface of the granular structure.

[12] The negative electrode active material according to [11] above, in which the carbon coating is 1% by mass to 10% by mass with an entire mass of the negative electrode active material as 100% by mass.

The present invention also has the following aspect:

[13] A method for manufacturing the negative electrode active material according to any one of [1] to [13] above, the method including Steps (1) to (3) below:
Step (1) a step of obtaining a precursor for producing a surface layer;
Step (2) a step of applying the precursor for producing a surface layer to a surface of a granular structure having surface unevenness and mainly containing graphite; and
Step (3) a step of firing the granular structure at a high temperature with a firing temperature of 1,000° C. to 1,300° C. in an inert atmosphere to obtain a negative electrode active material.

[14] A method for manufacturing a negative electrode active material, the method including covering powder of the negative electrode active material obtained in [13] above with a carbon coating in a temperature range of 700° C. to 1,000° C. in a flow of a thermally decomposable carbon source gas and a carrier inert gas in a chemical vapor deposition apparatus.

The present invention also has the following aspect:

[15] A secondary battery containing the negative electrode active material according to any one of [1] to [14] above.

### Advantageous Effects of Invention

The present invention provides a negative electrode active material giving a secondary battery having high initial discharge capacity, capacity retention rate, and charge-discharge capacity and having an excellent balance of these characteristics and a secondary battery containing the negative electrode active material.

### DESCRIPTION OF EMBODIMENTS

A negative electrode active material of the present invention (hereinafter also referred to as the “present negative electrode active material”) has a granular structure having a surface uneven part and mainly containing graphite (hereinafter also referred to as the “present granular structure”) and a surface layer with silicon particles with an average particle size of 20 nm to 200 nm dispersed in a matrix phase at least on part of the surface of the present granular structure.

Conventionally, for the purpose of increasing the capacity of lithium secondary batteries, combined use of silicon, which has a higher theoretical capacity than that of graphite, has been considered. However, silicon is known to expand in volume up to about three to four times as much along with lithium insertion, resulting in self-destructing or peeling off from the electrode. It is known that consequently when an active material containing silicon is used in a negative electrode, the cycle characteristics of the resulting lithium secondary battery decrease.

To prevent the volume expansion, as described in PTL 1 to 4 above, a method of covering the surface of graphite with silicon particles or making silicon particles adhere to the surface, a method of introducing a three-dimensional reticulate structure, and the like have been developed. However, the strength of the graphite and the silicon particles is insufficient in PTL 1 to 4, and it is considered that peeling or desorption of silicon particles due to volume expansion and contraction of the active material during charging and discharging is not prevented.

It is considered that the present negative electrode active material contains the granular structure having surface unevenness and mainly containing graphite and has the surface layer with silicon particles dispersed in the matrix phase at least on part of the surface of the present granular structure, by which the strength of the graphite and the silicon particles has been improved. It is considered that consequently the initial discharge capacity, the capacity retention rate, and the charge-discharge capacity of a secondary battery containing the present negative electrode active material have been improved.

The present granular structure mainly contains graphite. With the mass of the present granular structure as 100% by mass, the content of the graphite is preferably more than 50% by mass and more preferably 80% by mass or more.

Examples of the graphite as the main component include natural graphite, artificial graphite, and amorphous carbon such as hard carbon and soft carbon. The graphite is preferably natural graphite or artificial graphite from the viewpoint of the initial discharge capacity or the charge-discharge capacity.

In addition to the graphite, the present granular structure may contain carbon nanotubes, carbon fibers, a small amount of a binder used during a granulation step, or the like.

When the graphite is natural graphite or artificial graphite, the graphite preferably has an average particle size of 1 μm to 25 μm and a specific surface area of 0.5 m²/g to 20 m²/g from the viewpoint of achieving both improvement in surface layer adhesion strength by roughening the surface of graphite particles and prevention of graphite surface side effects during charging and discharging.

The average particle size is a D50 value that can be measured using a laser diffraction particle size analyzer or the like. D50 can be measured by dynamic light scattering using a laser particle size analyzer or the like. The average particle size is the particle size at which accumulation is 50% when a cumulative volume distribution curve is drawn from the small size side in a particle size distribution. In the following, the average particle size refers to D50.

The specific surface area is the BET specific surface area obtained through the BET equation using a specific surface area measurement apparatus by nitrogen gas adsorption measurement. In the following, the specific surface area refers to the BET specific surface area.

The present granular structure has the surface uneven part. The uneven part is only required to be formed on part of the surface of the present granular structure and may be formed on the entire surface. The uneven part may be formed on the surface of the present granular structure continuously or formed intermittently. The uneven part may be formed regularly or formed irregularly.

The uneven part may be formed by, for example, roughening the surface of the present granular structure, or the uneven part may be made by forming a plurality of holes on the surface. When the holes are formed, the holes may be open holes or communicating holes.

An unevenness depth, which is an average of the distance between the deepest part and the highest part adjacent to each other of the uneven part, is preferably 0.01 or more and more preferably 0.05 or more in terms of the ratio of the unevenness depth to the particle size of the present granular structure from the viewpoint of adhesive strength between the surface layer described below and the present granular structure. If the ratio is 0.3 or more, the mechanical performance of the granular structure may decrease, and it may be difficult for the surface layer to penetrate into the uneven part of the granular structure, producing voids in the active material, which may cause a reduction in performance due to electrolyte penetration during charging and discharging.

Examples of the sectional shape of the uneven part include shapes such as triangular, rectangular, semi-circular, and semi-elliptical shapes, and several of these shapes may be mixed together.

The average particle size of the present granular structure is preferably 1 μm to 30 μm and more preferably 3 μm to 20 μm.

The specific surface area of the present granular structure is preferably 1 m²/g to 30 m²/g and more preferably 3 m²/g to 20 m²/g. When the specific surface area is in the above range, appropriate surface voids can be maintained in order to maintain adhesion with the surface layer.

The present granular structure preferably has a cumulative pore volume of pore size in a range of 3 nm to 300 nm of 0.001 cm³/g or more from the viewpoint of maintaining adhesion with the surface layer. The cumulative pore volume of pore size is a cumulative pore volume with a pore size in a range of 2 nm or more and 100 nm or less among pores measured by the mercury injection method. The mercury injection method is a method in which mercury is injected into the inside of a hardened body and the distribution of pore size is measured from the relation between the pressure at the time and the amount of penetration, which is calculated assuming that the shape of the pores is cylindrical.

The cumulative pore volume is more preferably 0.01 cm³/g or more. The upper limit of the cumulative pore volume is normally 0.5 cm³/g.

The present negative electrode active material has the surface layer with silicon particles with an average particle size of 20 nm to 200 nm (hereinafter also referred to as the “present silicon particles”) dispersed in the matrix phase at least on part of the surface of the present granular structure.

The average particle size of the present silicon particles is the value of D50 described above. The average particle size of the present silicon particles is preferably 100 nm or less and more preferably 80 nm or less from the viewpoint of improvement in cycle performance. The average particle size of the present silicon particles is preferably 20 nm or more and more preferably 30 nm or more from the viewpoint of maintaining good dispersibility of silicon nanoparticles.

The particle size of the present silicon particles is preferably widely distributed from 5 nm to 300 nm in a range satisfying the above average particle size. By using silicon particles having different particle sizes in a wide range, it is easy to increase the packing density of the silicon particles in the present active material. Being widely distributed means that the shape of the particle size distribution is not limited to a particular shape, and it is only required that particles are present in the above particle size range. When the particle size of the present silicon particles is widely distributed, particles may be concentrated in some range of particle size, and a normal distribution is preferred. The silicon particles with the particle size widely distributed can be produced by, for example, dry or wet mechanical pulverizing methods.

The present silicon particles include zero-valent silicon and can be obtained by, for example, making silicon lumps particles by pulverization or the like such that the average particle size is within the above range.

Examples of pulverizers for use in the pulverization of silicon lumps include pulverizers such as ball mills, bead mills, and jet mills. Pulverization may be wet pulverization using an organic solvent, and as the organic solvent, for example, alcohols, ketones, and the like are suitably used, and aromatic hydrocarbon-based solvents such as toluene, xylene, naphthalene, and methyl naphthalene can also be used.

By appropriately controlling the pulverization conditions of the silicon particles, the average particle size is made within the above range, and finally classification or the like is performed, thereby obtaining the present silicon particles.

The present silicon particles may be granular, needle-like, or flake-like in shape so long as they are in a range meeting the above average particle size, but flake-like silicon particles are preferred from the viewpoint of improvement in active material performance. When the present silicon particles are flake-like, they are crystalline, and a crystallite size obtained from a peak at 2θ of 28.4° in an X-ray diffraction spectrum of 40 nm or less is preferred from the viewpoint of the initial coulombic efficiency and the capacity retention rate. The crystallite size is more preferably 30 nm or less. The crystallite size is more preferably 10 nm or more.

As the compound forming the matrix phase, compounds containing silicon, oxygen, and carbon are preferred, and the compounds containing silicon, oxygen, and carbon are preferably a structure including a three-dimensional network structure of a silicon-oxygen-carbon skeleton and free carbon. The free carbon is carbon that is not included in the silicon-oxygen-carbon three-dimensional skeleton. The free carbon includes carbon present as a carbon phase, carbon as carbons bonded together in the carbon phase, and carbon as carbons bonded between the silicon-oxygen-carbon skeleton and the carbon phase.

When the compound forming the matrix phase is the compound containing silicon, oxygen, and carbon and is the structure including the three-dimensional network structure of the silicon-oxygen-carbon skeleton and the free carbon, the silicon-oxygen-carbon skeleton in the matrix phase has high chemical stability and has a composite structure with the free carbon, thereby facilitating diffusion of lithium ions along with a reduction in electronic transition resistance. The present silicon particles are densely surrounded by the composite structure of the silicon-oxygen-carbon skeleton and the free carbon, thus hindering direct contact between the present silicon particles and an electrolyte. Consequently, when the present negative electrode active material is used as a negative electrode, while the present silicon particles in the negative electrode serve as the main component for exhibiting the charge-discharge performance, the chemical reaction between silicon and the electrolyte is avoided during charging and discharging, so that performance degradation of the present silicon particles can be prevented to the maximum extent.

In the silicon-oxygen-carbon skeleton, the electron distribution inside the silicon-oxygen-carbon skeleton fluctuates by the approach of lithium ions, and electrostatic bonds, coordination bonds, and the like are formed between the silicon-oxygen-carbon skeleton and lithium ions. Owing to these electrostatic bonds or coordination bonds, lithium ions are stored in the silicon-oxygen-carbon skeleton. Meanwhile, the coordination bond energy is relatively low, and thus the desorption reaction of lithium ions is easily performed. In other words, it is thought that the silicon-oxygen-carbon skeleton can reversibly cause the insertion and desorption reactions of lithium ions during charging and discharging.

When the matrix phase has a structure containing free carbon, the free carbon is preferably amorphous carbon.

When the compound forming the matrix phase is the compound containing silicon, oxygen, and carbon, the matrix phase preferably contains silicon oxycarbide represented by Formula (2) below:

SiOxCy (2)

In Formula (2), x represents the molar ratio of oxygen to silicon and y represents the molar ratio of carbon to silicon.

From the viewpoint that the balance between the charge-discharge performance and the capacity retention rate becomes predominant when the present negative electrode active material is used in a secondary battery, 1≤x<2 is preferred, 1.1≤x≤1.8 is more preferred, and 1.2≤x≤1.7 is even more preferred.

From the viewpoint of the balance between the charge-discharge performance and the initial charge-discharge efficiency when the present active material is used in a secondary battery, 1≤y≤20 is preferred, and 1.2≤y≤15 is more preferred.

The compound forming the matrix phase may contain nitrogen apart from silicon, oxygen, and carbon. Nitrogen can be introduced into the matrix phase by causing raw materials used in a method for producing the present active material described below, such as phenolic resins, dispersants, polysiloxane compounds, and other nitrogen compounds, and nitrogen gas or the like used in a firing process to have an atomic group containing nitrogen as a functional group in their molecules. The matrix phase containing nitrogen tends to be excellent in the charge-discharge performance and the capacity retention rate when the present negative electrode active material is used.

When the compound forming the matrix phase is the compound containing silicon, oxygen, carbon, and nitrogen, the matrix phase preferably contains a compound represented by Formula (3) below:

SiOxCyNz (3)

In Formula (3), x and y have the same meaning as above, and z represents the molar ratio of nitrogen to silicon.

When the matrix phase contains the compound represented by Formula (3) above, from the viewpoint of the charge-discharge performance and the capacity retention rate when the present active material is used in a secondary battery, 1≤x≤2, 1≤y≤20, and 0≤z≤0.5 are preferred, and 1.1≤x≤1.8, 1.2≤y≤15, and 0≤z≤0.4 are more preferred.

The above x, y and z can be determined by measuring the mass content of each element and then converting it to molar ratio (atom number ratio). In this process, the contents of oxygen and carbon can be determined by using an inorganic element analyzer, and the content of silicon can be determined by using an ICP optical emission spectrometer (ICP-OES).

It is preferable to measure x, y, and z by the methods described above, but it is also possible to measure them by performing a local analysis of the present active material and acquiring many measurement points of content ratio data obtained thereby to analogize the content ratio of the entire present negative electrode active material. Examples of the local analysis include energy dispersive X-ray spectroscopy (SEM-EDX) and an electron probe microanalyzer (EPMA).

The surface layer that the present negative electrode active material has at least on part of the present granular structure contains the present silicon particles, and the silicon oxycarbide and amorphous carbon as the free carbon as the matrix phase in which the present silicon particles are dispersed, and the present silicon particles are preferably contained in an amount of 1 to 80% by mass with the entire mass of the surface layer as 100% by mass.

Examples of the amorphous carbon include carbon from thermal decomposition of organic matter such as aromatic resins.

In addition to the above, the surface layer preferably contains nitrogen from the viewpoint of Si—O—C skeleton stability. When the surface layer contains nitrogen, the matrix phase preferably contains the compound represented by Formula (3) above.

The surface layer contains the present silicon particles in an amount of preferably 10% by mass or more and more preferably 15% by mass or more. The surface layer contains the present silicon particles in an amount of preferably 80% by mass or less and more preferably 70% by mass or less.

The present negative electrode active material preferably contains the surface layer in an amount of 1% by mass to 80% by mass with the entire mass of the present negative electrode active material as 100% by mass from the viewpoint of the charge-discharge capacity, the initial efficiency, and the cycle performance. The present negative electrode active material more preferably contains the surface layer in an amount of 5% by mass or more and even more preferably contains the surface layer in an amount of 10% by mass or more with the entire mass of the present negative electrode active material as 100% by mass from the viewpoint of improving the charge-discharge capacity. The present negative electrode active material more preferably contains the surface layer in an amount of 70% by mass or less and even more preferably contains the surface layer in an amount of 60% by mass or less with the entire mass of the present negative electrode active material as 100% by mass from the viewpoint of the cycle performance and the initial efficiency.

The entire mass of the present negative electrode active material is the total mass of the present granular structure and the surface layer included in the present negative electrode active material. When the matrix phase contains nitrogen, the total amount includes nitrogen as well. When the present negative electrode active material contains a covering layer described below, the entire mass of the present negative electrode active material is the total amount including the mass of the covering layer in addition to the above.

The present negative electrode active material, having the surface layer at least on part of the surface of the present granular structure, preferably has the surface layer on 80% or more of the surface of the present granular structure and more preferably has the surface layer on 90% or more of the surface of the present granular structure from the viewpoint of reducing the specific surface area and rationalizing a microstructure.

In the present negative electrode active material, the penetration depth of the surface layer into the interior of recesses of the granular structure preferably satisfies Expression (1) above.

0.01≤B/A≤0.3 (1)

in Expression (1), A represents the average particle size of the present granular structure and B represents the penetration depth of the surface layer into the interior of the recesses. A is D50 described above and B is measured by SEM observation of a particle cross section.

A and B above preferably satisfy Expression (4) below and more preferably satisfy Expression (5) below from the viewpoint of granular structure strength and surface layer adhesion:

0.05≤B/A≤0.25 (4)

0.10≤B/A≤0.20 (5)

The present negative electrode active material may contain another necessary third component apart from the above.

The surface of the present negative electrode active material may be covered with a covering material. As the covering material, preferred is a substance that can be expected to have electron conductivity, lithium ion conductivity, and the effect of inhibiting electrolyte decomposition.

When the surface of the present negative electrode active material is covered with the covering material, the average thickness of a coating is preferably 10 nm or more and 300 nm or less. The average thickness of the coating is preferably 20 nm or more and 200 nm or less. The present negative electrode active material having the coating with the above average thickness can protect the present silicon particles exposed on the surface of the granular structure, by which when the present negative electrode active material is used, the chemical stability and thermal stability of the negative electrode active material are improved. Consequently, the reduction in the charge-discharge performance of the secondary battery to be obtained can be further inhibited.

When the surface of the present negative electrode active material is covered with the coating, from the viewpoint of improving the chemical stability and thermal stability of the negative electrode active material, the content of the coating is preferably 1 to 30% by mass and more preferably 3 to 25% by mass with the entire mass of the present negative electrode active material as 100% by mass. The entire mass of the present negative electrode active material is the same as described above.

Examples of the coating include electron conductive materials such as carbon, titanium, and nickel. Among these, from the viewpoint of improving the chemical stability and thermal stability of the negative electrode active material, carbon is preferred, and low crystalline carbon is more preferred.

When the coating is carbon, the average thickness of the carbon coating is preferably 10 nm or more and 300 nm or less, or the content of carbon is preferably 1 to 10% by mass with the entire amount of the present negative electrode active material as 100% by mass. The entire amount of the present negative electrode active material is the same as described above.

In the case of the carbon coating, the coating is preferably produced by chemical vapor deposition (CVD).

In the case of the carbon coating, the scattering peak intensity ratio I (the G band/the D band) of the above Raman spectrum is preferably in a range of 0.9 to 1.1. The specific surface area by the BET method is preferably 3.5 m²/g or less, and the true density is preferably 1.9 g/cm³ or more.

The present negative electrode active material has high initial discharge capacity, capacity retention rate, and charge-discharge capacity and also has an excellent balance of these characteristics, and thus a secondary battery containing the present negative electrode active material as a battery negative electrode exhibits good charge-discharge characteristics.

Specifically, slurry containing the present negative electrode active material and an organic binding agent and other components such as conductivity aids as needed is applied to a current collector copper foil in the form of a thin film, which can be a negative electrode. The negative electrode can also be produced by adding carbon materials such as graphite to the above slurry.

Examples of these carbon materials include natural graphite, artificial graphite, and amorphous carbon such as hard carbon and soft carbon.

The negative electrode can be obtained by kneading the present negative electrode active material and a binder as an organic binding agent together with a solvent with a dispersion apparatus such as a stirrer, a ball mill, a super sand mill, or a pressure kneader to prepare negative electrode material slurry, which is then applied to a current collector to form a negative electrode layer, for example. The negative electrode layer can also be obtained by forming the paste-like negative electrode material slurry into a sheet shape, a pellet shape, or the like and integrating it with the current collector.

Examples of the organic binding agent include styrene-butadiene rubber copolymers (hereinafter also referred to as “SBR”); unsaturated carboxylic acid copolymers such as (meth)acrylic copolymers containing ethylenically unsaturated carboxylic esters such as methyl (meth)acrylate, ethyl (meth)acrylate, butyl (meth)acrylate, (meth)acrylonitrile, and hydroxyethyl (meth)acrylate and ethylenically unsaturated carboxylic acids such as acrylic acid, methacrylic acid, itaconic acid, fumaric acid, and maleic acid; and polymer compounds such as polyvinylidene fluoride, polyethylene oxide, polyepichlorohydrin, polyphosphazene, polyacrylonitrile, polyimide, polyamideimide, and carboxymethylcellulose (hereinafter also referred to as “CMC”).

These organic binding agents are dispersed or dissolved in water or dissolved in an organic solvent such as N-methyl-2-pyrrolidone (NMP) depending on their physical properties. The content ratio of the organic binding agent in a negative electrode layer of a lithium-ion secondary battery negative electrode is preferably 1% by mass to 30% by mass, more preferably 2% by mass to 20% by mass, and even more preferably 3% by mass to 15% by mass.

The content ratio of the organic binding agent being 1% by mass or more gives better adhesion and more inhibits the destruction of a negative electrode structure due to expansion and contraction during charging and discharging. On the other hand, being 30% by mass or less more inhibits an increase in electrode resistance.

In the range, the present negative electrode active material is easy to handle in terms of practical implementation in that it has high chemical stability and can employ a water-based binder.

The negative electrode material slurry may be mixed with a conductivity aid as needed. Examples of the conductivity aid include carbon black, graphite, acetylene black, and oxides and nitrides exhibiting conductivity. The use amount of the conductivity aid may be about 1% by mass to 15% by mass with respect to the negative electrode active material according to the present invention.

As to the material and shape of the current collector, for example, a strip of copper, nickel, titanium, stainless steel, or the like formed into a foil shape, a perforated foil shape, a mesh shape, or the like may be used. Porous materials such as porous metal (foamed metal) and carbon paper can also be used.

Examples of the method for applying the negative electrode material slurry to the current collector include metal mask printing, electrostatic coating, dip coating, spray coating, roll coating, doctor blading, gravure coating, and screen printing. After the application, rolling treatment with a flat press, a calender roll, or the like is preferably performed as needed.

The negative electrode material slurry in sheet form, pellet form, or the like can be integrated with the current collector by, for example, rolling, pressing, or a combination of these methods.

The negative electrode layer formed on the current collector or the negative electrode layer integrated with the current collector is preferably heat treated in accordance with the used organic binding agent. For example, when an SBR dispersed in water or the like is used, heat treatment may be performed at 100 to 130° C., whereas when an organic binding agent with polyimide or polyamideimide as its main skeleton is used, heat treatment is preferably performed at 150 to 450° C.

This heat treatment advances removal of the solvent and higher strength due to the hardening of the binder, which can improve adhesion between particles and between the particles and the current collector. This heat treatment is preferably performed in an inert atmosphere such as helium, argon, or nitrogen or a vacuum atmosphere in order to prevent oxidation of the current collector during the treatment.

The negative electrode is preferably subjected to pressurization after the heat treatment. A negative electrode containing the present negative electrode active material has an electrode density of preferably 1 g/cm³ to 1.8 g/cm³, more preferably 1.1 g/cm³ to 1.7 g/cm³, and even more preferably 1.2 g/cm³ to 1.6 g/cm³. As to the electrode density, higher density tends to improve adhesion and electrode volumetric capacity density. On the other hand, if the electrode density is too high, the number of voids in the electrode decreases, thereby weakening the effect of inhibiting volume expansion such as silicon, and the capacity retention rate may decrease. Thus, the optimal range of the electrode density is selected.

The secondary battery according to the present invention contains the present negative electrode active material in the negative electrode. The secondary battery having the negative electrode containing the present negative electrode active material is preferably a nonaqueous electrolyte secondary battery and a solid electrolyte secondary battery and exhibits excellent performance when used as the negative electrode of the nonaqueous electrolyte secondary battery in particular.

When used for a wet electrolyte secondary battery, for example, the secondary battery according to the present invention can be formed by placing a positive electrode and the negative electrode containing the negative electrode active material according to the present invention facing each other via a separator and injecting an electrolyte.

The positive electrode can be obtained by forming a positive electrode layer on the surface of a current collector, similarly to the negative electrode. For the current collector of this case, a strip of metal or alloy such as aluminum, titanium, or stainless steel formed into a foil shape, a perforated foil shape, a mesh shape, or the like can be used.

The positive electrode material for use in the positive electrode layer is not limited to a particular material. Among nonaqueous electrolyte secondary batteries, when a lithium-ion secondary battery is produced, metallic compounds, metal oxides, metal sulfides, or conductive polymer materials capable of doping or intercalating lithium ions may be used, for example. Examples thereof include lithium cobaltate (LiCoO₂), lithium nickelate (LiNiO₂), lithium manganate (LiMnO₂), their composite oxides (LiCoxNiyMnzO₂, x+y+z=1), lithium manganese spinel (LiMn₂O₄), lithium vanadium compounds, V₂O₅, V₆O₁₃, VO₂, MnO₂, TiO₂, MoV₂O₈, TiS₂, V₂S₅, VS₂, MoS₂, MoS₃, Cr₃O₈, Cr₂O₅, olivine type LiMPO₄ (where M is Co, Ni, Mn, or Fe), conductive polymers such as polyacetylene, polyaniline, polypyrrole, polythiophene, and polyacene, and porous carbon, which can be used singly or in mixture.

As the separator, nonwoven fabrics, cloth, microporous films, or combinations thereof mainly made of polyolefins such as polyethylene and polypropylene can be used, for example. When a structure in which the positive electrode and the negative electrode of the nonaqueous electrolyte secondary battery to be produced are not in direct contact is employed, there is no need to use any separator.

As the electrolyte, for example, what is called an organic electrolyte can be used, in which a lithium salt such as LiClO₄, LiPF₆, LiAsF₆, LiBF₄, or LiSO₃CF₃ is dissolved in a nonaqueous solvent as a single body or a mixture of two or more components such as ethylene carbonate, propylene carbonate, butylene carbonate, vinylene carbonate, fluoroethylene carbonate, cyclopentanone, sulfolane, 3-methylsulfolane, 2,4-dimethylsulfolane, 3-methyl-1,3-oxazolidin-2-one, γ-butyrolactone, dimethyl carbonate, diethyl carbonate, ethylmethyl carbonate, methylpropyl carbonate, butylmethyl carbonate, ethylpropyl carbonate, butylethyl carbonate, dipropyl carbonate, 1,2-dimethoxyethane, tetrahydrofuran, 2-methyl tetrahydrofuran, 1,3-dioxolane, methyl acetate, or ethyl acetate.

While the structure of the secondary battery according to the present invention is not limited to a particular structure, it is generally structured by winding the positive electrode, the negative electrode, and the separator, which is provided as needed, into a flat spiral shape to make a wound electrode plate group or stacking them into a flat plate shape to make a laminated electrode plate group and encapsulating these electrode plate groups in an outer casing. A half cell for use in the examples of the present invention mainly includes the present active material in its negative electrode, and simplified evaluation is performed with metallic lithium used for the counter electrode. This is for comparing the cycle characteristics of the active material itself more clearly.

The secondary battery containing the present negative electrode active material is used as, for example, paper batteries, button batteries, coin batteries, laminated batteries, cylindrical batteries, square batteries, and the like. The present negative electrode active material can also be applied to electrochemical apparatuses in general using insertion and desorption of lithium ions as a charge-discharge mechanism, such as hybrid capacitors and solid lithium secondary batteries.

The present negative electrode active material can be produced by a method including, for example, Steps 1 to 3 below. The following steps exemplify a method using a polysiloxane compound as the matrix phase, but these methods are not limiting.
Step (1) a step of obtaining a precursor for producing a surface layer;
Step (2) a step of applying the precursor for producing a surface layer to a surface of a granular structure having surface unevenness and mainly containing graphite; and
Step (3) a step of firing the granular structure at a high temperature with a firing temperature of 1,000° C. to 1,300° C. in an inert atmosphere to obtain a negative electrode active material.

### <Step (1)>

The precursor for producing a surface layer giving the surface layer with silicon particles dispersed in the matrix phase is produced by the following method.

The silicon particles are obtained by, for example, pulverizing silicon lumps with a wet powder pulverizing apparatus using an organic solvent. A dispersant may be used in order to promote the pulverization of the silicon lumps in the organic solvent. As the silicon lumps, commercially available silicon powders, large particle size silicon particles, and the like are used.

The wet pulverizing apparatus is not limited to a particular apparatus. Examples thereof include roller mills, high-speed rotary pulverizers, container-driven mills, and bead mills.

In wet pulverization, the silicon particles are preferably pulverized until they reach the particle size of the present silicon particles.

Examples of the organic solvent used in the wet process include organic solvents that do not chemically react with silicon. Examples thereof include acetone, methyl ethyl ketone, methyl isobutyl ketone, and diisobutyl ketone as ketones; ethanol, methanol, normal propyl alcohol, and isopropyl alcohol as alcohols; and benzene, toluene, and xylene as aromatics.

Examples of the type of the dispersant include aqueous and nonaqueous dispersants. The use of the nonaqueous dispersant is preferred in order to inhibit excessive oxidation to the surfaces of the silicon particles. Examples of the type of the nonaqueous dispersant include a polymeric type such as polyether-based, polyalkylene polyamine-based, and polycarboxylic acid partial alkyl ester-based ones, a low molecular type such as polyhydric alcohol ester-based and alkyl polyamine-based ones, and an inorganic type such as polyphosphate-based one. The concentration of silicon in the wet pulverization is not limited to a particular concentration, but the amount of silicon is preferably in a range of 5% by mass to 40% by mass and more preferably 10% by mass to 30% by mass with the total amount of the solvent, the dispersant, if the dispersant is contained as needed, and silicon as 100% by mass.

When silicon particles with broadly distributed particle size from 5 nm to 300 nm are used as the present silicon particles, such silicon particles can be prepared by the following method.

Examples include control of a plurality of pulverization conditions such as the addition amount of the dispersant, a bead diameter, the number of revolutions, and a pulverization time using a wet bead mill apparatus.

A polysiloxane compound can be used as a raw material for the matrix phase in which the present silicon particles are dispersed. The polysiloxane compound is a resin containing at least one of a polycarbosilane structure, a polysilazane structure, a polysilane structure, and a polysiloxane structure. The polysiloxane compound may be a resin containing only these structures or a composite resin having at least one of these structures as a segment and chemically bonding with another polymer segment. Examples of the form of combination include graft copolymerization, block copolymerization, random copolymerization, and alternating copolymerization. Examples thereof include a composite resin having a graft structure chemically bonding with a polysiloxane segment and a side chain of the polymer segment and a composite resin having a block structure in which the polysiloxane segment chemically bonds with the end of the polymer segment.

The polysiloxane segment preferably has a structural unit represented by General Formula (S-1) below and/or General Formula (S-2) below. Among them, the polysiloxane compound more preferably has a carboxy group, an epoxy group, an amino group, or a polyether group on the side chain or the end of a siloxane bond (Si—O—Si) main skeleton.

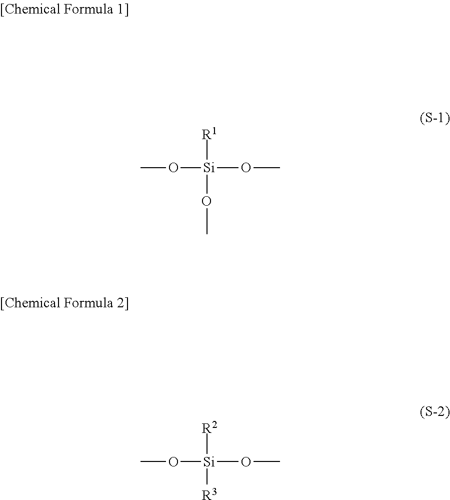

(In General Formulae (S-1) and (S-2) above, R¹ represents an aromatic hydrocarbon group or an alkyl group that may have a substituent, an epoxy group, a carboxy group, or the like. R² and R³ each indicate an alkyl group, a cycloalkyl group, an aryl group, an aralkyl group, an epoxy group, a carboxy group, or the like.)

Examples of the alkyl group include a methyl group, an ethyl group, a propyl group, an isopropyl group, a butyl group, an isobutyl group, a sec-butyl group, a tert-butyl group, a pentyl group, an isopentyl group, a neopentyl group, a tert-pentyl group, a 1-methylbutyl group, a 2-methylbutyl group, a 1,2-dimethylpropyl group, a 1-ethylpropyl group, a hexyl group, an isohexyl group, a 1-methylpentyl group, a 2-methylpentyl group, a 3-methylpentyl group, a 1,1-dimethylbutyl group, a 1,2-dimethylbutyl group, a 2,2-dimethylbutyl group, a 1-ethylbutyl group, a 1,1,2-trimethylpropyl group, a 1,2,2-trimethylpropyl group, a 1-ethyl-2-methylpropyl group, and a 1-ethyl-1-methylpropyl group. Examples of the cycloalkyl group include a cyclopropyl group, a cyclobutyl group, a cyclopentyl group, and a cyclohexyl group.

Examples of the aryl group include a phenyl group, a naphthyl group, a 2-methylphenyl group, a 3-methylphenyl group, a 4-methylphenyl group, a 4-vinylphenyl group, and a 3-isopropylphenyl group.

Examples of the aralkyl group include a benzyl group, a diphenylmethyl group, and a naphthylmethyl group.

Examples of the polymer segment that the polysiloxane compound has, other than the polysiloxane segment, include polymer segments such as vinyl polymer segments such as acrylic polymers, fluoro olefin polymers, vinyl ester polymers, aromatic vinyl polymers, and polyolefin polymers, polyurethane polymer segments, polyester polymer segments, and polyether polymer segments. Among them, vinyl polymer segments are preferred.

The polysiloxane compound may be a composite resin in which the polysiloxane segment and the polymer segment bond with each other in the structure shown by Structural Formula (S-3) below and may have a three-dimensional reticulate polysiloxane structure.

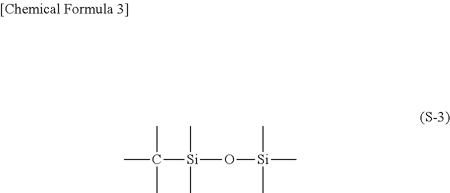

(In the formula, the carbon atom is a carbon atom forming the polymer segment, and the two silicon atoms are silicon atoms forming the polysiloxane segment.)

The polysiloxane segment of the polysiloxane compound may have a functional group in the polysiloxane segment that can react upon heating, such as a polymerizable double bond. Heat treatment on the polysiloxane compound prior to thermal decomposition allows a cross-linking reaction to proceed, making it solid, which can facilitate thermal decomposition treatment.

Examples of the polymerizable double bond include a vinyl group and a (meth)acryloyl group. Two or more polymerizable double bonds are preferably present in the polysiloxane segment, 3 to 200 are more preferably present, and 3 to 50 are even more preferably present. By using a composite resin with two or more polymerizable double bonds as the polysiloxane compound, a cross-linking reaction can be easily caused to proceed.

The polysiloxane segment may have a silanol group and/or a hydrolyzable silyl group. Examples of a hydrolyzable group in the hydrolyzable silyl group include halogen atoms, an alkoxy group, a substituted alkoxy group, an acyloxy group, a phenoxy group, a mercapto group, an amino group, an amide group, an aminooxy group, an iminooxy group, and an alkenyloxy group. These groups are hydrolyzed, whereby the hydrolyzable silyl group become a silanol group. In parallel with the thermosetting reaction, a hydrolytic condensation reaction proceeds between the hydroxy group in the silanol group and the hydrolyzable group in the hydrolyzable silyl group to obtain a solid polysiloxane compound.

The silanol group referred to in the present invention is a silicon-containing group having a hydroxy group directly bonding with the silicon atom. The hydrolyzable silyl group referred to in the present invention is a silicon-containing group having a hydrolyzable group directly bonding with the silicon atom. Specific examples thereof include a group represented by General Formula (S-4) below.

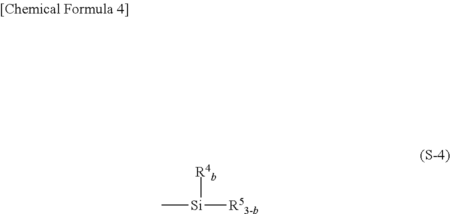

(In the formula, R⁴ is a monovalent organic group such as an alkyl group, an aryl group, or an aralkyl group, and R⁵ is a halogen atom, an alkoxy group, an acyloxy group, an allyloxy group, a mercapto group, an amino group, an amide group, an aminooxy group, an iminooxy group, or an alkenyloxy group, in which b is an integer of 0 to 2.)

Examples of the alkyl group include a methyl group, an ethyl group, a propyl group, an isopropyl group, a butyl group, an isobutyl group, a sec-butyl group, a tert-butyl group, a pentyl group, an isopentyl group, a neopentyl group, a tert-pentyl group, a 1-methylbutyl group, a 2-methylbutyl group, a 1,2-dimethylpropyl group, a 1-ethylpropyl group, a hexyl group, an isohexyl group, a 1-methylpentyl group, a 2-methylpentyl group, a 3-methylpentyl group, a 1,1-dimethylbutyl group, a 1,2-dimethylbutyl group, a 2,2-dimethylbutyl group, a 1-ethylbutyl group, a 1,1,2-trimethylpropyl group, a 1,2,2-trimethylpropyl group, a 1-ethyl-2-methylpropyl group, and a 1-ethyl-1-methylpropyl group.

Examples of the aryl group include a phenyl group, a naphthyl group, a 2-methylphenyl group, a 3-methylphenyl group, a 4-methylphenyl group, a 4-vinylphenyl group, and a 3-isopropylphenyl group.

Examples of the aralkyl group include a benzyl group, a diphenylmethyl group, and a naphthylmethyl group.

Examples of the halogen atom include a fluorine atom, a chlorine atom, a bromine atom, and an iodine atom.

Examples of the alkoxy group include a methoxy group, an ethoxy group, a propoxy group, an isopropoxy group, a butoxy group, a secondary butoxy group, and a tertiary butoxy group.

Examples of the acyloxy group include a formyloxy group, an acetoxy group, a propanoyloxy group, a butanoyloxy group, a pivaloyloxy group, a pentanoyloxy group, a phenylacetoxy group, an acetoacetoxy group, a benzoyloxy group, and a naphthoyloxy group.

Examples of the allyloxy group include a phenyloxy group and a naphthyloxy group.

Examples of the alkenyloxy group include a vinyloxy group, an allyloxy group, a 1-propenyloxy group, an isopropenyloxy group, a 2-butenyloxy group, a 3-butenyloxy group, a 2-pentenyloxy group, a 3-methyl-3-butenyloxy group, and a 2-hexenyloxy group.

Examples of the polysiloxane segment having the structural units indicated by General Formula (S-1) above and/or General Formula (S-2) above include those having the following structures.

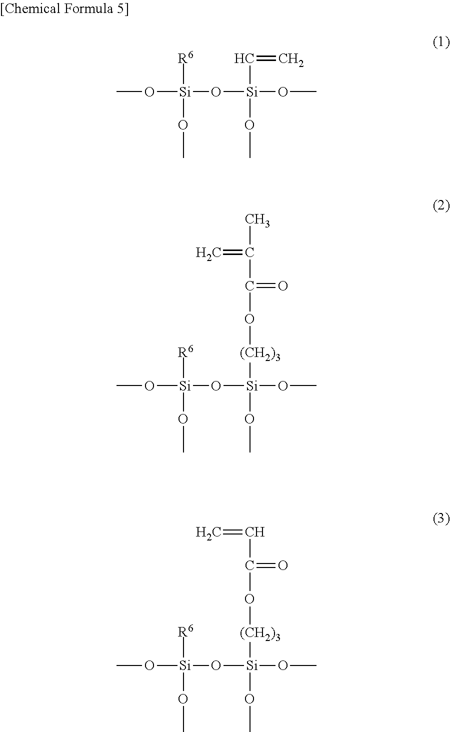

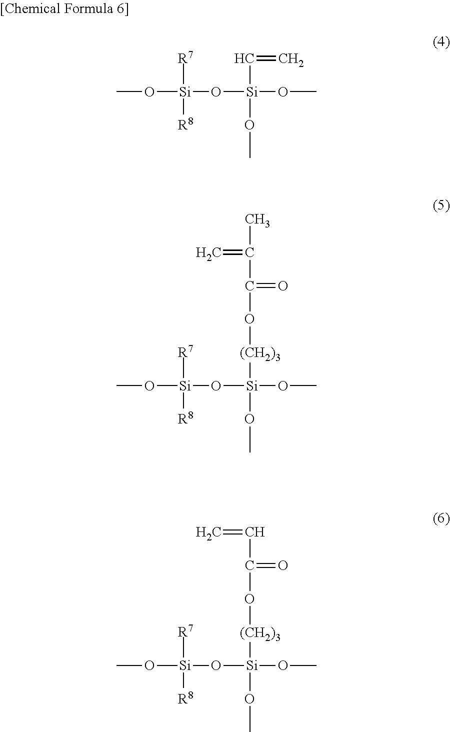

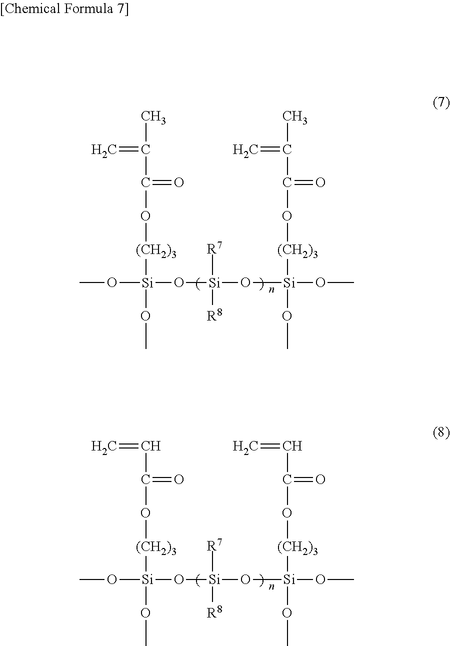

The polymer segment may have various functional groups as needed to the extent that they do not impair the advantageous effects of the present invention. Examples of such functional groups include a carboxy group, a blocked carboxy group, a carboxylic anhydride group, a tertiary amino group, a hydroxy group, a blocked hydroxy group, a cyclocarbonate group, an epoxy group, a carbonyl group, a primary amide group, a secondary amide group, a carbamate group, and a functional group represented by Structural Formula (S-5) below.

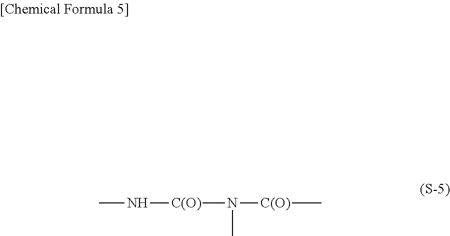

The polymer segment may also have a polymerizable double bond such as a vinyl group or a (meth)acryloyl group.

The polysiloxane compound is preferably produced by, for example, the methods shown in (4) to (6) below.

(4) A method of preparing a polymer segment containing a silanol group and/or a hydrolyzable silyl group as a raw material for the polymer segment in advance, mixing this polymer segment and a silane compound containing a silanol group and/or a hydrolyzable silyl group and a polymerizable double bond together, and performing a hydrolytic condensation reaction.

(5) This method prepares a polymer segment containing a silanol group and/or a hydrolyzable silyl group as a raw material for the polymer segment in advance. A silane compound containing a silanol group and/or a hydrolyzable silyl group and a polymerizable double bond is subjected to a hydrolytic condensation reaction to also prepare polysiloxane in advance. Then, the polymer segment and polysiloxane are mixed together, and a hydrolytic condensation reaction is performed.

(6) A method of mixing the polymer segment, a silane compound containing a silanol group and/or a hydrolyzable silyl group and a polymerizable double bond, and polysiloxane together and performing a hydrolytic condensation reaction.

The polysiloxane compound is obtained by the methods described above.

Examples of the polysiloxane compound include the CERANATE (registered trademark) series (organic/inorganic hybrid coating resin; manufactured by DIC Corporation) and the COMPOCERAN SQ series (silsesquioxane-type hybrid; manufactured by Arakawa Chemical Industries, Ltd.).

As another raw material for the matrix phase, a carbon source resin is used. For the carbon source resin, synthetic resins having aromatic functional groups as well as natural raw materials or the like having good miscibility with the polysiloxane compound and are carbonized by high-temperature firing in an inert atmosphere are preferably used.

Examples of the synthetic resins include thermoplastic resins such as polyvinyl alcohol and polyacrylic acid and thermosetting resins such as phenolic resins and furan resins. Examples of the natural chemical raw materials include heavy oils, especially tar pitches such as coal tar, tar light oil, tar medium oil, tar heavy oil, naphthalene oil, anthracene oil, coal tar pitch, pitch oil, mesophase pitch, oxygen cross-linked petroleum pitch, and heavy oil. From the viewpoint of availability at low prices and exclusion of impurities, phenolic resins are more preferably used.

In particular, the carbon source resin is preferably a resin containing an aromatic hydrocarbon moiety, and the resin containing an aromatic hydrocarbon moiety is preferably a phenolic resin, an epoxy resin, or a thermosetting resin, with the phenolic resin being preferably a resol type one.

Examples of the phenolic resin include the Sumilite Resin series (resol type phenolic resin, manufactured by Sumitomo Bakelite Co., Ltd.).

The slurry of silicon particles obtained in the above is mixed with the polysiloxane compound and the carbon source resin to obtain a suspension liquid in which the silicon particles, the polysiloxane compound, and the carbon source resin are uniformly dispersed.

The obtained suspension liquid is subjected to desolventing and drying to obtain the precursor for producing a surface layer. The mixture containing the polysiloxane compound and the carbon source resin is preferably in a state in which the polysiloxane compound and the carbon source resin are uniformly mixed together. The mixing is performed using an apparatus having dispersing and mixing functions. Examples of the apparatus include stirrers, ultrasonic mixers, and premix dispersion machines. In the desolventing and drying operations for the purpose of distilling off an organic solvent, dryers, vacuum dryers, spray dryers, or the like can be used.

The precursor for producing a surface layer preferably contains the present silicon particles in an amount of 3% by mass to 50% by mass, the solid content of the polysiloxane compound in an amount of 15% by mass to 85% by mass, and the solid content of the carbon source resin in an amount of 3% by mass to 70% by mass and more preferably contains the content of the solid content of the present silicon particles in an amount of 8% by mass to 40% by mass, the solid content of the polysiloxane compound in an amount of 20 to 70% by mass, and the solid content of the carbon source resin in an amount of 3% by mass to 60% by mass.

### <Step (2)>

In Step (2), the precursor for producing a surface layer obtained in Step (1) above is applied to the surface of the present granular structure.

Examples of the method of application include a method of adding the present granular structure to a slurry containing the precursor for producing a surface layer, mixing them together, and then performing desolventing and drying. The mixing, the desolventing, and the drying are the same as those in Step (1) above.

For the granular structure having surface unevenness and mainly containing graphite, for example, graphite and a pore-forming agent or a small amount of a resin binder are uniformly mixed together, and the mixture is once molded into a pellet shape, a granular shape, a flake shape, or the like using, for example, a press. Subsequently, by removing the pore-forming agent or the resin binder, the granular structure having surface unevenness can be produced.

The pore-forming agent is used to form pores in a molded body by being removed from the molded body by firing, etching, washing, or the like after the molding. The material of the pore-forming agent is selected as appropriate according to the method for removing the pore-forming agent. Examples thereof include metals, such as copper, which are poor in acid resistance or alkali resistance, inorganic materials, which have a lower firing temperature than that of graphite, and organic materials, which are easily thermally decomposed.

### <Step (3)>

In Step (3), the present granular structure to which the precursor for producing a surface layer has been applied obtained in Step (2) above is fired at a high temperature with a temperature of 1,000° C. to 1,300° C. in an inert atmosphere to obtain the present negative electrode active material. By the firing, thermally decomposable organic components are completely decomposed, and the other main components are made into a fired product suitable for the present negative electrode active material by the precise control of the firing conditions. Specifically, the polysiloxane compound and the carbon source resin as raw materials are converted to a silicon-oxygen-carbon skeleton and free carbon by the energy of the high-temperature processing.

In Step (3), by firing the present granular structure to which the precursor for producing a surface layer has been applied obtained in Step (2) above in the above temperature range in an inert atmosphere, the microstructure of the present negative electrode active material can be precisely controlled, and oxidation of the present silicon particles during high-temperature firing can be avoided, resulting in even better charge-discharge characteristics.

While the method of firing is not limited to a particular method, a reaction apparatus having a heating function in an inert atmosphere may be used, and continuous or batch processing is possible. As to the apparatus for firing, fluidized bed reactors, rotary furnaces, vertical moving bed reactors, tunnel furnaces, batch furnaces, rotary kilns, or the like can be selected as appropriate in accordance with the purpose.

The present negative electrode active material obtained in Step (3) above may be pulverized and classified as needed. The pulverization may be performed with a bead mill, a jet mill, or the like. The classification can be performed using a wind power classifier, a wet classifier, or the like. If a precursor mixture is controlled to a shape near the target particle size by spray drying or the like prior to the firing in Step (3), and the firing is performed in that shape, the pulverization step can be omitted.

When the present negative electrode active material has the carbon coating, by, for example, subjecting the present negative electrode active material obtained in Steps (1) to (3) above to chemical vapor deposition on the conditions of a flow of a thermally decomposable carbon source gas and a carrier nitrogen gas and high temperature processing within a temperature range of 700° C. to 1,000° C. in a chemical vapor deposition apparatus, the present negative electrode active material formed with the carbon coating can be obtained.

As described above, when the present negative electrode active material is made into the negative electrode active material of a secondary battery, it gives a secondary battery excellent in the initial coulombic efficiency and the capacity retention rate.

The present active material can be used as the negative electrode by the above method and can be made into a secondary battery having the negative electrode.

The above has described the present negative electrode active material, the secondary battery containing the present negative electrode active material in the negative electrode, and the method for manufacturing the present negative electrode active material, but the present invention is not limited to the configuration of the embodiment.

For the present active material and the secondary battery containing the present active material in the negative electrode, any other configurations may be added to the configuration of the embodiment, or the configuration may be replaced with any configurations performing similar functions.

For the method for manufacturing the present negative electrode active material, the configuration of the embodiment may additionally have any other steps, or the steps may be replaced with any steps producing similar effects.

### EXAMPLES

The following describes the present invention in detail by means of examples, but the present invention is not limited to these examples.

A half cell for use in the examples of the present invention mainly includes the silicon-containing active material according to the present invention in its negative electrode, and simplified evaluation is performed with metallic lithium used for the counter electrode. This is for comparing the cycle characteristics of the active material itself more clearly.

### Synthesis Example 1: Production of Silicon Particles

Zirconia beads with a particle size of 0.1 mm to 0.2 mm and 100 ml of methyl ethyl ketone solvent (MEK) were put into a container of a 150 ml small-sized bead mill apparatus with a filling rate of 60%. Subsequently, silicon powder (a commercially available product) with an average particle size of 5 μm and a cationic dispersant liquid (BYK-Chemie Japan K.K.: BYK145) were added thereto, and the mixture was subjected to bead mill wet pulverization under the conditions described in Table 1 to obtain dark brown, liquid silicon slurries Si1 to Si6 with a solid concentration of 30% by mass.

The morphology and size of the silicon pulverized product were confirmed by TEM observation, and they were designated as Si1, Si2, Si3, Si4, Si5, and Si6 as listed in Table 1.

TABLE 1

| | | | | | | | | Si | |
|---|---|---|---|---|---|---|---|---|---|
| | | | | | | | Si | particle | |
| | | | Zirconia | Zirconia | | | average | size | |
| | | Disper- | beads | beads/ | Number of | | particle | distri- | |
| | | sant/Si | particle | Si | revolutions | Pulver- | size | bution | Si |
| | Disper- | weight | size | weight | (revolutions/ | ization | D50 | range | particle |
| | sant | ratio | mm | ratio | minute) | time h | (nm) | (nm) | shape |
| Si | Present | 1/10 | 0.2 | 2/1 | 1,500 | 4 | 150 | 5-300 | Flake |
| 1 | | | | | | | | | |
| Si | Present | 1/7 | 0.2 | 2/1 | 1,500 | 4 | 100 | 5-261 | Flake |
| 2 | | | | | | | | | |
| Si | Present | 1/5 | 0.2 | 2/1 | 1,500 | 4 | 57 | 5-156 | Flake |
| 3 | | | | | | | | | |
| Si | Present | 1/5 | 0.1 | 2/1 | 1,500 | 4 | 56 | 5-156 | Flake |
| 4 | | | | | | | | | |
| Si | Absent | — | 0.2 | 2/1 | 1,500 | 2 | 250 | 38-530 | Bulk |
| 5 | | | | | | | | | particle |
| Si | Present | 1/2 | 0.1 | 5/1 | 1,500 | 24 | 15 | 3-78 | Flake |
| 6 | | | | | | | | | |

### Synthesis Example 2: Processing to Impart Unevenness to Graphite Particle Surfaces

For Graphites 1 to 7, 200 g of copper particles having an average particle size listed in Table 2 were added to 200 g of a spherical graphite powder with an average particle size in a range of 2.5 μm to 15 μm listed in Table 2, which were mixed together in a tabletop mixer for 30 minutes and were then molded into a cylindrical shape with a molding machine at a pressure of 40 to 80 MPa as listed in Table 2. The molded product was pulverized in a mortar, and the pulverized product was immersed in a 10% by mass sulfuric acid solution for 24 hours at room temperature to dissolve and remove the copper. After filtration of the mixture liquid, it was dried under reduced pressure at 110° C. for 12 hours to impart voids to the surface of the graphite powder.

The unevenness depth on the graphite surface was measured by sectional observation with a SEM, and the average particle size, the specific surface area, the pore volume, and the like of graphite particles were determined using a light scattering particle size measurement apparatus and a specific surface area measurement apparatus. Table 2 lists the results.

For Graphite 8, a 15 μm spherical graphite powder was pulverized under a ball mill condition using zirconia balls with a particle size of 5 mm for 10 hours to make the average particle size of graphite 1.5 μm, and voids were imparted using copper particles with an average particle size of 1 μm, and then the copper was dissolved and removed. For Graphite 9, a 15 μm spherical graphite powder and copper particles with an average particle size of 1 μm were molded into a cylindrical shape with a molding machine at a pressure of 35 MPa, and then the copper was dissolved and removed under the above conditions to impart voids.

For Graphite 10, a spherical graphite powder with an average particle size of 2.5 μm and copper particles with an average particle size of 1 μm were molded into a cylindrical shape with a molding machine at a pressure of 70 MPa, and then the copper was dissolved and removed under the above conditions to impart voids.

Table 2 lists the conditions for imparting voids for Graphites 1 to 10.

TABLE 2

| | | | | Uneven- | | | |
|---|---|---|---|---|---|---|---|
| | Copper | | Un- | ness | Graphite | Cumu- | Spe- |
| | average | | even- | depth/ | average | lative | cific |
| Graphite | particle | Pres- | ness | graphite | particle | pore | surface |
| particle | size | sure | depth | particle | size | volume | area |
| type | μm | MPa | μm | size | μm | m³/g | m²/g |
| Graphite | 2 | 60 | 0.8 | 0.05 | 15 | 0.006 | 2.5 |
| 1 | | | | | | | |
| Graphite | 3 | 70 | 2.5 | 0.17 | 15 | 0.007 | 2.5 |
| 2 | | | | | | | |
| Graphite | 5 | 80 | 3.8 | 0.25 | 15 | 0.008 | 2.6 |
| 3 | | | | | | | |
| Graphite | 1 | 50 | 0.4 | 0.16 | 2.5 | 0.01 | 7.9 |
| 4 | | | | | | | |
| Graphite | 2 | 60 | 0.8 | 0.08 | 10 | 0.008 | 3 |
| 5 | | | | | | | |
| Graphite | 2 | 50 | 0.6 | 0.15 | 4 | 0.011 | 4.2 |
| 6 | | | | | | | |
| Graphite | 1 | 40 | 0.32 | 0.13 | 2.5 | 0.012 | 7.8 |
| 7 | | | | | | | |
| Graphite | 1 | 35 | 0.25 | 0.17 | 1.5 | 0.03 | 12.7 |
| 8 | | | | | | | |
| Graphite | 1 | 35 | 0.25 | 0.017 | 15 | 0.002 | 2.4 |
| 9 | | | | | | | |
| Graphite | 1 | 70 | 0.84 | 0.34 | 2.5 | 0.018 | 10.1 |
| 10 | | | | | | | |

### Synthesis Example 3: Production of Polysiloxane Compound

### (Synthesis of Condensate of Methyltrimethoxysilane)

Methyltrimethoxysilane (hereinafter abbreviated as “MTMS”) in 1,421 parts by mass was charged into a reaction vessel including a stirrer, a thermometer, a dropping funnel, a cooling tube, and a nitrogen gas inlet, and the temperature thereof was raised up to 60° C. Next, to the reaction vessel, a mixture of 0.17 part by mass of iso-propyl acid phosphate (“Phoslex A-3” manufactured by SC Organic Chemical Co., Ltd.) and 207 parts by mass of deionized water was added dropwise over 5 minutes, and then the mixture was stirred at a temperature of 80° C. for 4 hours to be caused to undergo a hydrolytic condensation reaction.

The condensate obtained by the hydrolysis condensation reaction was distilled at a temperature of 40 to 60° C. and a reduced pressure of 40 to 1.3 kPa, and methanol and water produced in the reaction process were removed to obtain 1,000 parts by mass of liquid containing a condensate of MTMS with a number average molecular weight of 1,000 to 5,000 with an effective component of 70% by mass. The term “under reduced pressure from 40 to 1.3 kPa” refers to a condition in which the reduced pressure condition at the start of distilling off methanol is 40 kPa, which is reduced until the pressure is finally 1.3 kPa. The effective component is calculated by a value obtained by dividing a theoretical yield (parts by mass) when all methoxy groups of silane monomers such as MTMS have undergone the condensation reaction by an actual yield (parts by mass) after the condensation reaction [theoretical yield (parts by mass) when all methoxy groups of silane monomers have undergone condensation reaction/actual yield (parts by mass) after condensation reaction].

### (Production of Curable Resin Composition (1))

Into a reaction vessel including a stirrer, a thermometer, a dropping funnel, a cooling tube, and a nitrogen gas inlet, 150 parts by mass of butanol (hereinafter also referred to as “BuOH”), 105 parts by mass of phenyltrimethoxysilane (hereinafter also referred to as “PTMS”), and 277 parts by mass of dimethyldimethoxysilane (hereinafter also referred to as “DMDMS”) were charged, and the temperature thereof was raised up to 80° C.

Next, at the same temperature, a mixture containing 21 parts by mass of methyl methacrylate (hereinafter also referred to as “MMA”), 4 parts by mass of butyl methacrylate (hereinafter also referred to as “BMA”), 3 parts by mass of butyric acid (hereinafter also referred to as “BA”), 2 parts by mass of methacryloyloxypropyltrimethoxysilane (hereinafter also referred to as “MPTS”), 3 parts by mass of BuOH, and 0.6 part by mass of butyl peroxy-2-ethylhexanoate (hereinafter also referred to as “TBPEH”) was added dropwise to the reaction vessel over 6 hours. After completion of the dropwise addition, it was further reacted at the same temperature for 20 hours to obtain an organic solvent solution of a vinyl polymer (a2-1) with a number average molecular weight of 10,000 having a hydrolyzable silyl group.

Next, a mixture of 0.04 part by mass of iso-propyl acid phosphate (“Phoslex A-3” manufactured by SC Organic Chemical Co., Ltd.) and 112 parts by mass of deionized water was added dropwise over 5 minutes, and the mixture was further stirred at the same temperature for 10 hours to cause it to undergo a hydrolytic condensation reaction, thereby obtaining a liquid containing a composite resin in which a hydrolyzable silyl group having the vinyl polymer (a2-1), a hydrolyzable silyl group having polysiloxane derived from PTMS and DMDMS described above, and a silanol group bond with each other.

Next, to this liquid, 472 parts by mass of the condensate (a1) of MTMS obtained in Synthesis Example 1 and 80 parts by mass of deionized water were added, the mixture was stirred at the same temperature for 10 hours to cause it to undergo a hydrolytic condensation reaction, and produced methanol and water were removed by performing distillation under the same conditions as in Synthesis Example 1. Next, 250 parts by mass of BuOH was added to obtain 1,000 parts by mass of a curable resin composition (1) with a nonvolatile content of 60.1% by mass.

### (Production of Curable Resin Composition (2))

Into a reaction vessel including a stirrer, a thermometer, a dropping funnel, a cooling tube, and a nitrogen gas inlet, 150 parts by mass of BuOH, 249 parts by mass of PTMS, and 263 parts by mass of DMDMS were charged, and the temperature thereof was raised up to 80° C. Next, at the same temperature, a mixture containing 18 parts by mass of MMA, 14 parts by mass of BMA, 7 parts by mass of BA, 1 part by mass of acrylic acid (hereinafter also referred to as “AA”), 2 parts by mass of MPTS, 6 parts by mass of BuOH, and 0.9 part by mass of TBPEH was added dropwise to the reaction vessel over 5 hours. After completion of the dropwise addition, they were further reacted at the same temperature for 10 hours to obtain an organic solvent solution of a vinyl polymer (a2-2) with a number average molecular weight of 20,100 having a hydrolyzable silyl group.

Next, a mixture of 0.05 part by mass of iso-propyl acid phosphate (“Phoslex A-3” manufactured by SC Organic Chemical Co., Ltd.) and 147 parts by mass of deionized water was added dropwise over 5 minutes, and the mixture was further stirred at the same temperature for 10 hours to cause it to undergo a hydrolytic condensation reaction, thereby obtaining a liquid containing a composite resin in which a hydrolyzable silyl group of the vinyl polymer (a2-2), a hydrolyzable silyl group of polysiloxane derived from PTMS and DMDMS described above, and a silanol group bond with each other.

Next, to this liquid, 76 parts by mass of 3-glycidoxypropyltrimethoxysilane, 231 parts by mass of the condensate of MTMS, and 56 parts by mass of deionized water were added, the mixture was stirred at the same temperature for 15 hours to cause it to undergo a hydrolytic condensation reaction, and produced methanol and water were removed by performing distillation under the same conditions as above, and then 250 parts by mass of BuOH was added to obtain 1,000 parts by mass of a curable resin composition (2) with a nonvolatile content of 60.0% by mass.

### Example 1

The polysiloxane resin with an average molecular weight of 3,500 produced in Synthesis Example 3 above (curable resin (1)) and a phenolic resin with an average molecular weight of 3,000 were added in a resin solid weight composition ratio of 45/55 such that a composition weight ratio SiOC/C after firing was 50/50, and the Si3 silicon slurry obtained in Synthesis Example 1 and an appropriate amount of methyl ethyl ketone solvent were added thereto such that the silicon particle content in the product after high-temperature firing was 50% by mass, and the mixture was thoroughly mixed in a stirrer.

Consequently, a silicon particle-containing resin-mixed suspension liquid with a solid concentration of 10% by mass was obtained. Graphite 2 processed in Synthesis Example 2 above was added to 100 parts by mass of the silicon particle-containing resin-mixed suspension liquid so as to be 94% by mass after high-temperature firing, and after mixing thoroughly, desolventing was performed under a nitrogen flow condition in an oil bath at 120° C. Subsequently, vacuum drying was performed at 110° C. for 10 hours using a vacuum dryer, and finally high-temperature firing was performed in a nitrogen atmosphere at 1,100° C. for 4 hours to obtain composite particles as a black solid. The composite particles were pulverized with a planetary ball mill to produce an active material. The average particle size was about 16 μm in terms of D50 and the specific surface area by the BET method was 3.1 m²/g. The crystallite size determined by the Scherrer equation based on the FWHM at 2θ of 28.4° as a diffraction peak attributed to the Si (111) crystal plane based on a measurement result of powder X-ray diffraction (XRD) using the Cu-Kα line was 21 nm.

The obtained active material powder in an amount of 80 parts, 10 parts of acetylene black as a conductivity aid, and 10 parts of a mixture of CMC and SBR as a binder were mixed together to prepare slurry, which was formed as a film on copper foil. After drying it under reduced pressure at 110° C., a half cell of a coin type lithium secondary battery was produced with a Li metal foil as the counter electrode, and charge-discharge characteristics were evaluated using a secondary battery charge-discharge test apparatus (manufactured by Hokuto Corporation). The cutoff voltage range was set to 0.005 to 1.5 V. The charge-discharge measurement results showed an initial discharge capacity of 403 mAh/g and an initial coulombic efficiency of 90%.

For the evaluation of a full cell, a positive electrode film was produced using a single-layer sheet including, as positive electrode materials, LiCoO₂ as a positive electrode active material and an aluminum foil as a current collector, and a negative electrode film was produced by mixing graphite powder and the active material powder at a designed discharge capacity value of 400 mAh/g. Using a nonaqueous electrolyte solution in which lithium hexafluorophosphate was dissolved in a 1/1 mixed liquid of ethylene carbonate and diethyl carbonate in terms of volume ratio at a concentration of 1 mol/L as a nonaqueous electrolyte, a laminated lithium-ion secondary battery including a 30 μm-thick polyethylene microporous film as a separator was produced. The laminated lithium-ion secondary battery was charged under room temperature at a constant current of 1.2 mA (0.25 c based on the positive electrode) until the test cell voltage reached 4.2 V, and after reaching 4.2 V, charging was performed with the current decreased so as to keep the cell voltage at 4.2 V to determine discharge capacity. The capacity retention rate after 300 cycles at 25° C. was 91%. Table 3 lists the results.

### Examples 2 to 9

As in Example 1, the addition amount of Graphite 2 processed in Synthesis Example 2 to 100 parts by mass of the silicon particle-containing resin-mixed suspension liquid of Si3 obtained in Synthesis Example 1 with a solid concentration of 10% by mass was adjusted so as to be 90% by mass to 50% by mass after firing as listed in Table 3. After mixing thoroughly, desolventing was performed under a nitrogen gas flow condition in an oil bath at 120° C. Active materials were obtained with the other conditions being the same as in Example 1. Each secondary battery containing a negative electrode active material containing the obtained active material was evaluated. Table 3 lists the results.

### Examples 10 to 17

Using a curable resin (2) with an average molecular weight of 3,200, Graphite 1 (Example 10), Graphite 3 (Example 11), Graphite 4 (Example 12), Graphite 5 (Example 13), Graphite 6 (Example 14), Graphite 7 (Example 15), Graphite 8 (Example 16), and Graphite 3 (Example 17) processed in Synthesis Example 2 were put into 100 parts by mass of the silicon particle-containing resin-mixed suspension liquid of Si3 obtained in Synthesis Example 1 with a solid concentration of 10% by mass so as to be 85% by mass each after firing. After mixing thoroughly, desolventing was performed under a nitrogen gas flow condition in an oil bath at 120° C. Active materials were obtained with the other conditions being the same as in Example 1. Each secondary battery containing a negative electrode active material containing the obtained active material was evaluated. Table 4 lists the results.

### Examples 18 to 20

Graphite 2 processed in Synthesis Example 2 was put into 100 parts by mass of the silicon particle-containing resin-mixed suspension liquid of Si1 (Example 18), Si2 (Example 19), and Si4 (Example 20) obtained in Synthesis Example 1 with a solid concentration of 10% by mass so as to be 85% by mass each in high-temperature firing, and the mixture was thoroughly mixed together. Subsequently, desolventing was performed under a nitrogen gas flow condition in an oil bath at 120° C. Active materials were obtained with the other conditions being the same as in Example 1. Subsequently, 25 g of each of the active material powders was put into a reaction vessel of a chemical vapor deposition apparatus (CVD, disk rotary kiln, Takasago Industry Co., Ltd.), and carbon coating was performed with the reaction time changed to 1 hour, 2 hours, and 3 hours at 900° C. in a mixed gas flow with a flow rate of 0.3 L/min for acetylene and a flow rate of 0.7 L/min for nitrogen. Thermal analysis results showed that the amounts of carbon coating were 2%, 4%, and 8%, respectively. Table 4 lists the properties of the obtained carbon coating active materials and the evaluation results of the secondary batteries.

### Example 21

Using commercially available monodisperse spherical silicon particles with an average particle size D50 of 50 nm (manufactured by Alfa Aesar), a resin-mixed suspension liquid containing 10 parts by mass of solid concentration was prepared under the same conditions as in Example 1. Graphite 2 processed in Synthesis Example 2 was put into 100 parts by mass of the above resin-mixed suspension liquid so as to be 85% by mass after high-temperature firing, and after mixing thoroughly, desolventing was performed under a nitrogen gas flow condition in an oil bath at 120° C. An active material was obtained with the other conditions being the same as in Example 1. A secondary battery containing a negative electrode active material containing the obtained active material was evaluated. Table 4 lists the results.

### Example 22

Using the Si3 silicon particles obtained in Synthesis Example 1 above, a resin-mixed suspension liquid containing 10 parts by mass of solid concentration was prepared under the same conditions as in Example 1. Graphite 9 processed in Synthesis Example 2 was put into 100 parts by mass of the above resin-mixed suspension liquid so as to be 85% by mass after high-temperature firing, and after mixing thoroughly, desolventing was performed under a nitrogen gas flow condition in an oil bath at 120° C. An active material was obtained with the other conditions being the same as in Example 1. A secondary battery containing a negative electrode active material containing the obtained active material was evaluated. Table 4 lists the results.

### Example 23

Graphite 10 processed in Synthesis Example 2 was put into 100 parts by mass of the silicon particle-containing resin-mixed suspension liquid of Si3 obtained in Synthesis Example 1 with a solid concentration of 10% by mass so as to be 85% by mass after high-temperature firing, and after mixing thoroughly, desolventing was performed under a nitrogen gas flow condition in an oil bath at 120° C. An active material was obtained with the other conditions being the same as in Example 1. A secondary battery containing a negative electrode active material containing the obtained active material was evaluated. Table 4 lists the results.

### Comparative Example 1

Using a spherical graphite with an average particle size D50 of 15 μm, the particle size distribution and the specific surface area were measured, and then an active material was obtained in the same manner as in Example 1. A secondary battery containing a negative electrode active material containing the obtained active material was evaluated. Table 4 lists the results.

### Comparative Example 2

Commercially available graphite particles with an average particle size D50 of 15 μm were put into 100 parts by mass of the silicon particle-containing resin-mixed suspension liquid of Si5 obtained in Synthesis Example 1 with a solid concentration of 10% by mass so as to be 85% by mass after high-temperature firing, and the mixture was thoroughly mixed together. Subsequently, desolventing was performed under a nitrogen gas flow condition in an oil bath at 120° C. An active material was obtained with the other conditions being the same as in Example 1. A secondary battery containing a negative electrode active material containing the obtained active material was evaluated. Table 4 lists the results.

### Comparative Example 3

Commercially available graphite particles with an average particle size D50 of 15 μm were put into 100 parts by mass of the silicon particle-containing resin-mixed suspension liquid of Si6 obtained in Synthesis Example 1 with a solid concentration of 10% by mass so as to be 85% by mass after high-temperature firing, and the mixture was thoroughly mixed together. Subsequently, desolventing was performed under a nitrogen gas flow condition in an oil bath at 120° C. An active material was obtained with the other conditions being the same as in Example 1. A secondary battery containing a negative electrode active material containing the obtained active material was evaluated. Table 4 lists the results.

TABLE 3

| | | | | | | | | | | | | Negative | | | | |
|---|---|---|---|---|---|---|---|---|---|---|---|---|---|---|---|---|
| | | | | | | | | | | | | electrode | | | | |
| | | | | | | | | | | | | active | | | | |
| | | | | | | | | | | | | material | | | | |
| | | | | | | | | | | | | particle | | | | Capacity |
| | | | | | | Si | | SiOC/C | | | | average | Carbon | | Initial | retention |
| | | Graphite | Surface | Cumulative | | average | Si | composition | Si | | Specific | particle | coating | Initial | charge- | rate |
| | Graphite | content | penetration | pore | Si | particle | content | ratio | crystallite | Nitrogen | surface | size | amount | discharge | discharge | after 300 |
| | particle | mass | depth | volume | particle | size | mass | mass | size | content | area | (D50) | mass | capacity | efficiency | cycles |
| | Type | ratio % | X = B/A | m³/g | Type | nm | ratio % | ratio % | nm | % | m²/g | μm | ratio % | mAh/g | % | % |
| Example 1 | Graphite 2 | 94% | 0.17 | 0.007 | Si3 | 57 | 50% | 50:50 | 21 | 0.5 | 3.1 | 16 | 0 | 403 | 90.0% | 91% |
| Example 2 | Graphite 2 | 90% | 0.17 | 0.007 | Si3 | 57 | 50% | 50:50 | 21 | 0.6 | 3.4 | 16.6 | 0 | 466 | 89.3% | 90% |
| Example 3 | Graphite 2 | 85% | 0.17 | 0.007 | Si3 | 57 | 50% | 50:50 | 21 | 0.6 | 4 | 17.1 | 0 | 529 | 88.4% | 89% |
| Example 4 | Graphite 2 | 80% | 0.17 | 0.007 | Si3 | 57 | 50% | 50:50 | 21 | 0.5 | 4.5 | 17.9 | 0 | 592 | 87.7% | 86% |
| Example 5 | Graphite 2 | 75% | 0.17 | 0.007 | Si3 | 57 | 50% | 50:50 | 21 | 0.4 | 5.2 | 18.3 | 0 | 655 | 86.1% | 84% |
| Example 6 | Graphite 2 | 70% | 0.17 | 0.007 | Si3 | 57 | 50% | 50:50 | 21 | 0.6 | 5.6 | 18.5 | 0 | 718 | 85.5% | 83% |
| Example 7 | Graphite 2 | 65% | 0.17 | 0.007 | Si3 | 57 | 50% | 50:50 | 21 | 0.5 | 5.8 | 18.9 | 0 | 780 | 85.2% | 82% |
| Example 8 | Graphite 2 | 60% | 0.17 | 0.007 | Si3 | 57 | 50% | 50:50 | 21 | 0.7 | 5.9 | 19.1 | 0 | 841 | 84.9% | 81% |
| Example 9 | Graphite 2 | 50% | 0.17 | 0.007 | Si3 | 57 | 50% | 50:50 | 21 | 0.8 | 6 | 19.5 | 0 | 970 | 84.4% | 80% |

TABLE 4

| | | | | | | | | | | | | Negative | | | | |
|---|---|---|---|---|---|---|---|---|---|---|---|---|---|---|---|---|
| | | | | | | | | | | | | electrode | | | | |
| | | | | | | | | | | | | active | | | | |
| | | | | | | | | | | | | material | | | | |
| | | | | | | | | | | | | particle | | | | Capacity |
| | | | | | | Si | | SiOC/C | | | | average | Carbon | | Initial | retention |
| | | Graphite | Surface | | | average | Si | composition | Si | | Specific | particle | coating | Initial | charge- | rate |
| | Graphite | content | penetration | Cumulative | Si | particle | content | ratio | crystallite | Nitrogen | surface | size | amount | discharge | discharge | after 300 |
| | particle | mass | depth | pore volume | particle | size | mass | mass | size | content | area | (D50) | mass | capacity | efficiency | cycles |
| | Type | ratio % | X = B/A | m³/g | Type | nm | ratio % | ratio % | nm | % | m²/g | μm | ratio % | mAh/g | % | % |
| Example 10 | Graphite 1 | 85% | 0.05 | 0.006 | Si3 | 57 | 50% | 50:50 | 21 | 0.4 | 3.1 | 17 | 0 | 531 | 87.9% | 83% |
| Example 11 | Graphite 3 | 85% | 0.25 | 0.008 | Si3 | 57 | 50% | 50:50 | 21 | 0.4 | 3.2 | 17.1 | 0 | 535 | 88.1% | 84% |
| Example 12 | Graphite 4 | 85% | 0.16 | 0.010 | Si3 | 57 | 50% | 50:50 | 21 | 0.4 | 8.5 | 3.1 | 0 | 529 | 87.4% | 87% |
| Example 13 | Graphite 5 | 85% | 0.08 | 0.008 | Si3 | 57 | 50% | 50:50 | 21 | 0.4 | 3.5 | 12.4 | 0 | 527 | 87.7% | 82% |
| Example 14 | Graphite 6 | 85% | 0.15 | 0.011 | Si3 | 57 | 50% | 50:50 | 21 | 0.4 | 4.7 | 6.8 | 0 | 544 | 86.2% | 36% |
| Example 15 | Graphite 7 | 85% | 0.13 | 0.012 | Si3 | 57 | 50% | 50:50 | 21 | 0.4 | 8.3 | 3 | 0 | 532 | 88.4% | 85% |
| Example 16 | Graphite 8 | 85% | 0.17 | 0.030 | Si3 | 57 | 50% | 50:50 | 21 | 0.4 | 9.2 | 2 | 0 | 539 | 88.9% | 85% |
| Example 17 | Graphite 3 | 85% | 0.25 | 0.008 | Si3 | 57 | 30% | 50:50 | 21 | 0.4 | 4.2 | 16.7 | 0 | 455 | 83.6% | 89% |
| Example 18 | Graphite 2 | 85% | 0.17 | 0.007 | Si1 | 150 | 50% | 50:50 | 38 | 0.3 | 4 | 17.2 | 2% | 542 | 90.2% | 81% |
| Example 19 | Graphite 2 | 85% | 0.17 | 0.007 | Si2 | 100 | 50% | 50:50 | 29 | 0.3 | 4.1 | 17.4 | 4% | 528 | 88.3% | 84% |
| Example 20 | Graphite 2 | 85% | 0.17 | 0.007 | Si4 | 56 | 50% | 50:50 | 20 | 0.4 | 4 | 17.8 | 8% | 520 | 89.1% | 90% |
| Example 21 | Graphite 2 | 85% | 0.17 | 0.007 | Commercially | 50 | 50% | 50:50 | 39 | 0.1 | 4.5 | 16 | 0 | 532 | 82.1% | 82% |
| | | | | | available | | | | | | | | | | | |
| | | | | | product | | | | | | | | | | | |
| Example 22 | Graphite 9 | 85% | 0.017 | 0.002 | Si3 | 57 | 50% | 50:50 | 21 | 0.4 | 3.1 | 16.5 | 0 | 533 | 89.8% | 81% |
| Example 23 | Graphite 10 | 85% | 0.34 | 0.018 | Si3 | 57 | 50% | 50:50 | 21 | 0.4 | 6 | 3.6 | 0 | 531 | 87.1% | 78% |
| Comparative | Commercially | 100% | 0 | 0.003 | — | — | — | — | — | — | 3 | 15 | 0 | 335 | 90.0% | 95% |
| Example 1 | available | | | | | | | | | | | | | | | |
| | product | | | | | | | | | | | | | | | |
| Comparative | Commercially | 85% | 0 | 0.003 | Si5 | 250 | 50% | 50:50 | 45 | 0.3 | 3.5 | 16 | 0 | 539 | 89.7% | 53% |
| Example 2 | available | | | | | | | | | | | | | | | |
| | product | | | | | | | | | | | | | | | |
| Comparative | Commercially | 85% | 0 | 0.003 | Si6 | 15 | 50% | 50:50 | 16 | 0.8 | 4.9 | 15.9 | 0 | 501 | 79.2% | 91% |
| Example 3 | available | | | | | | | | | | | | | | | |
| | product | | | | | | | | | | | | | | | |

[Methods of Evaluation]

In Table 3 and Table 4, the methods of evaluation are as follows:

D50: Measured using a laser diffraction particle size distribution analyzer (Mastersizer 3000 manufactured by Malvern Panalytical Ltd.).

Specific surface area: Measured by the BET method by nitrogen adsorption measurement using a specific surface area measurement apparatus (BELSORP-mini manufactured by BELJAPAN). ²⁹Si-NMR: JNM-ECA600 manufactured by JEOL RESONANCE Inc. was used.

Surface penetration depth: Measured with FE-SEM (JSM-7900F manufactured by JEOL Ltd.) after sectioning with FB-2100 (manufactured by Hitachi High-Tech Corporation).

Cumulative pore volume: Measured with a mercury porosimeter (AutoPore IV9520 manufactured by Shimadzu Corporation, Micromeritic).

Crystallite size: Measured with an X-ray diffractometer (SmartLab manufactured by Rigaku Corporation) and calculated using the Scherrer equation.

Specific surface area: Measured with a specific surface area measurement apparatus (BELSORP VAC3 manufactured by MicrotracBEL Corporation).

Battery characteristics evaluation: Battery characteristics were measured using a secondary battery charge-discharge tester (manufactured by Hokuto Denko Corporation). Evaluation tests of charge-discharge characteristics were conducted at room temperature of 25° C., with a cutoff voltage range of 0.005 to 1.5 V and a charge-discharge rate of 0.1 C (the first to third times) and 0.2 C (the fourth cycle and later), and under a setting condition of constant-current and constant-voltage charging/constant-current discharging. At the time of switching between each charging and discharging, the half battery was left at rest in an open circuit for 30 minutes. Initial discharge capacity, initial charge-discharge efficiency, and a capacity retention rate at 300 cycles were determined as follows.

Initial discharge capacity initial charge-discharge efficiency (%)=initial discharge capacity (mAh/g)/initial charge capacity (mAh/g) capacity retention rate (%@300th cycle)=discharge capacity at 300th cycle (mAh/g)/initial discharge capacity (mAh/g)

As is clear from the above results, the secondary batteries containing the present negative electrode active material show an initial discharge capacity of 400 or more, an initial efficiency of 80% or more, and a capacity retention rate at 300 cycles of 80% or more, which are all high, and the balance of these is excellent. It is considered that this is because compared to commercially available graphite, the graphite formed with surface unevenness has improved in adhesion strength with the surface layer, and consequently, the characteristics of the secondary batteries such as the initial discharge capacity have been improved.

1. A negative electrode active material comprising:
a granular structure having a surface uneven part and mainly containing graphite; and
a surface layer with silicon particles with an average particle size of 20 nm to 200 nm dispersed in a matrix phase at least on part of a surface of the granular structure.

2. The negative electrode active material according to claim 1, wherein
the silicon particles are flake-like and crystalline, and
a crystallite size with 2θ of 28.4° in X-ray diffraction is 40 nm or less.

3. The negative electrode active material according to claim 1, wherein a penetration depth of the surface layer into an interior of recesses of the granular structure satisfies Expression (1) below:
0.01≤B/A≤0.3 (1)
in the Expression (1), A represents an average particle size of the granular structure and B represents the penetration depth of the surface layer into the interior of the recesses.

4. The negative electrode active material according to claim 1, wherein the granular structure has a cumulative pore volume of pore size in a range of 3 nm to 300 nm of 0.001 cm³/g or more.

5. The negative electrode active material according to claim 1, wherein
the graphite is natural graphite or artificial graphite, and
the graphite has an average particle size of 1 μm to 25 μm and a specific surface area of 0.5 m²/g to 20 m²/g.

6. The negative electrode active material according to claim 1, wherein a mass of the surface layer is 1% by mass to 80% by mass with an entire mass of the negative electrode active material as 100%.

7. The negative electrode active material according to claim 1, wherein
the surface layer contains silicon oxycarbide, amorphous carbon, and the silicon particles, and
the silicon particles are 1 to 80% by mass with an entire mass of the surface layer as 100% by mass.

8. The negative electrode active material according to claim 7, wherein the surface layer further contains nitrogen.

9. The negative electrode active material according to claim 1, wherein a particle size of the silicon particles is distributed in a range of 5 nm to 300 nm.

10. The negative electrode active material according to claim 1, wherein the granular structure has an average particle size of 1 μm to 30 μm and a specific surface area of 1 m²/g to 30 m²/g.

11. The negative electrode active material according to claim 1, further comprising a carbon coating on the surface of the granular structure.

12. The negative electrode active material according to claim 11, wherein the carbon coating is 1% by mass to 10% by mass with an entire mass of the negative electrode active material as 100% by mass.

13. A method for manufacturing the negative electrode active material according to claim 1, the method comprising Steps (1) to (3) below:
Step (1) a step of obtaining a precursor for producing a surface layer;
Step (2) a step of applying the precursor for producing a surface layer to a surface of a granular structure having surface unevenness and mainly containing graphite; and
Step (3) a step of firing the granular structure at a high temperature with a firing temperature of 1,000° C. to 1,300° C. in an inert atmosphere to obtain a negative electrode active material.

14. A method for manufacturing a negative electrode active material, the method comprising covering powder of the negative electrode active material obtained in claim 13 with a carbon coating in a temperature range of 700° C. to 1,000° C. in a flow of a thermally decomposable carbon source gas and a carrier inert gas in a chemical vapor deposition apparatus.

15. A secondary battery comprising the negative electrode active material according to claim 1.
